(19) United States
(12) Patent Application Publication
(10) Pub. No.: US 2007/0271730 A1
(43) Pub. Date: Nov. 29, 2007

(54) Magnet for loose friction checks to rods including those of basic door closers

(76) Inventor: Ricardo Alonso, Denver, CO (US)

Correspondence Address: Ricardo Alonso, 111 S. Perry St., Denver, CO, 80219, US

(21) Appl. No.: 11/890,875

(22) Filed: Aug. 7, 2007

Related U.S. Application Data
(63) Continuation-in-part of application No. 10/797,396, filed on Mar. 9, 2004.

(51) Int. Cl. E05F 3/02

(52) U.S. Cl. 16/66

(57) ABSTRACT

A cup (70) comprising a magnet (72) and projected surfaces (74) for triggering (38) a loose compressive friction check (22) to disengage (22A) and engage (22B) certain rods (16), such as those for door closers (10) which are utilized for controlling linear biasing forces (11A) and (11B) for objects such as doors (62).

This is a Continuation-In-Part of Ser. No. 10/797,396 filed on Mar. 09, 2004 now abandoned.

### TECHNICAL FIELD

This invention relates to various reciprocating devices that control certain objects with linear biasing forces. Exemplified is a basic door closer that acts to return the door to a closed position. The device normally comprises a rod that reciprocates from within a closer body providing a biasing means to the forces. For holding the door in an opened position, the rod can be axially mounted with a loose frictional check mechanism. Also known as a hold-open tab, it mounts onto the rod through an aperture. When triggered, the tab frictionally engages the extended rod with opposing compressive points comprised within the aperture.

More particularly, this invention relates to the use of a magnetic means to control loose checks for engagement and release, such as for holding the door opened and then permitting closure. The numerous inventions disclosed herein might not be possible without including Alonso's other inventions to improve reciprocating devices, as described in U.S. Pat. Nos. D395,995; D425,776; D425,399; 5,953,789; 6,032,331; 6,397,431; 6,640,387. A portion of this disclosure contains material which is subject to copyright protection. There is no obligation to its reproduction in the US PTO, however all copyrights are reserved.

### BACKGROUND ART

Check mechanisms are normally metal stamped from sheet steel and comprise two relevant components to the invention herein: an aperture within a structure and a trigger. There are two types of checks: fixed and loose. Fixed checks are permanently mounted to the closer body using such as springs, levers, and cams as with U.S. Pat. No. 5,592,780. Loose checks are separate from the closer body and can be completely detached. The reader is encouraged to study a complete disclosure concerning various loose checks in U.S. Pat. No. 5,953,789.

The hold feature engages by first opening the door to a desired position which also extends the rod. A counter-force is then created as a result of the biasing means within the body. To hold, the check is axially positioned onto the extended rod through the aperture. Fixed checks are mechanically engaged by usage of a button or similar attached to the closer. Loose checks are manually engaged, simply moved onto the extended rod by the user's fingers. Releasing the door, the biasing means acts to return the extended rod for closure. Once the body or similar mechanisms contact the trigger, the biasing force causes the check to lever and torsionally pivot on the linear axis of the rod.

The check frictionally engages the extended rod with opposing compressive points within the aperture. The force is equalized and distributed by the points within an axial plane, interacting to deliver the compressive frictional pressure onto the rod. Thus, the compressive frictional pressure created by the points causes the check to engage the rod and hold the door.

Concerning loose checks, other than the inventor's most others utilize only two compressive friction points offered within the aperture, and a non-variable trigger. The two points are distantly opposed at no less than the rod diameter. Most two point checks are initially sufficient to hold the door opened, however eventually wear causing slippage on the rod and unintentional closure. Fatiguing points lack stability onto the smooth cylindrical surface of the rod, which causes the check to rotate laterally as more torsion is applied onto the trigger. This lateral rotation further inhibits the compressive friction, which ultimately causes the check to slip and fail. The non-variable trigger comprises a flattened plane. For whatever reason, non-variable two point checks continue to remain desirable among the industry perhaps as they initiate recurring door closer sales.

Comparatively, the inventor's check comprises an aperture that applies more than two opposing compressive points. The distance between the points is less than the rod diameter, which applies more friction and balances the check to overcome the lateral instability. The structure which houses the aperture is offset, separating the points over a larger tensile area. As the points wear they actually become stronger by distributing more compressive friction. The offset permits the check a perpendicular posture onto the rod which provides continual engagement. That is, the check keeps itself engaged by its own weight with no further pressure required. The offset also allows the check to substantially rotate in reversal up to 45° while disengaged, to allow it free-slide similar to a guide or bearing when not needed.

A variable trigger is defined in U.S. Pat. No. 6,032,331, although not entirely necessary for the inventions herein. The trigger comprises a continual curvature surface which increases the leverage for the compressive points, and, coincidentally decreases the applicable torsion required to engage the check. The more torsion applied to the trigger results in more compressive frictional pressure applied onto the rod.

Combining the above inventions creates a phenomenally strong and reliable loose check that should never slip or wear, as tested to over 300 lbs. of direct linear force continually applied to a present check. The amount of compressive frictional pressure that can be applied by the points is only limited by the tensile strength of the rod. Not even a coat of lubricant seems to affect the check once it engages.

There are several known options for engaging and releasing both fixed and loose check mechanisms, individually all presenting virtues and tribulations:

The first shall be referenced as Basic Tab Set, the most reliable way to hold a door opened and the only known purpose for a loose check. The loose check tab must be manually engaged onto the extended rod by the user, who must first open the door then slide the tab from idle. The tab's trigger contacts the closer body and torsionally causes the check to lever. However, in order to close the door the tab must again be returned back to idle. This basic option poses inconvenience particularly for children, and disabled people using mobility devices whom may not be able to easily move the tab. Fingers are often pinched by the trigger, especially when attempting to set a fatigued check.

The second option shall be reference as Immediate Tab Set, partially deriving from the inconveniences described above. A recent door closer comprises a pushbutton to engage a fixed check for holding the door. Once the button is pushed, a lever causes the check tab to immediately engage and hold the door opened. The most desirable feature about this device is that the user needs only to push the door further outward to cancel the check for closure. A spring within the body cancels the tab once the torsion to the trigger is relieved. However, the check tab may be compromised by premature closure from incidental bumping to the door. This becomes apparent when moving large objects through the doorway such as furniture, and especially for users of mobility devices such as wheelchairs and walkers.

The third option shall be referenced as Progressive Tab Set, available for holding the door at every outward position. Some devices use a dial adjacent to a fixed tab which is rotated for engagement. The most desirable feature about this device is that it omits premature closure, by the continual hold as the door is pushed outward. However, in order to close the dial must again be rotated which may too create difficulties for certain users.

The fourth option shall be referenced as Limited Tab Set, requiring that the door be opened to approx. 90° in order to engage a fixed tab. Similar to the pushbutton device, to close the user need only bump the door slightly outward to cancel the tab. However, most users may not always desire that their door be fully opened just for setting the check. Some manufactures for these devices are now including a separate loose tab for checking the door at less than the full open position.

Note that U.S. Pat. No. 5,592,780 describes an invention that utilizes an electromagnetic means (43) for controlling the check (26), however must not be construed as being anticipated by the inventive concepts described herein. Foremost, the check (26) is fix mounted and must be controlled by the latch plate (26) in order to utilize the magnetic head (43). Furthermore, for securing the check (26) onto the closer body (22) the latch (26) must be pinned to the flex plate (65) which is further secured by a backing plate (61), with all the above references housed a within a mounting container (51). Comparatively, the invention herein primarily requires a magnet to similarly control a loose check, absolutely different from the fixed check.

It becomes apparent that a single closer device should be created to encompass many of these check options, wherein each may become circumstantially available and disposable.

### DISCLOSURE OF THE INVENTION

These inventions relate to the use of a magnetic means to trigger loose check mechanisms for reciprocating devices, thus creating the first known door closer capable of most the check options described above. Objects of these inventions are to create a loose check tab capable of basic set, immediate set, and progressive set. Other objects of these inventions are to create inexpensive and reliable power for controlling the loose check, versus other fixed check mechanisms using such as springs, levers, and cams.

A primary magnet can be easily manufactured into the closer and into the check. However, for quick adaptation onto most every basic closer, the magnet can be housed within a simplistic plastic cup to easily retrofit without substantial modification to the closer device. Objects of these inventions are to utilize components having no fasteners, no moving parts, and minimal cost.

The cup or end cap of the closer further comprises projected surfaces that control the various check and trigger options. Objects of these inventions are to stabilize the check onto the closer body while both disengaged and engaged. Other objects are to create versatility for the check and the device. Other objects are to eliminate the lateral instability know with some checks. Other objects are to utilize the invention onto every loose check variety including those consisting of only two compressive friction points and including a non-variable trigger.

### DESCRIPTION OF THE DRAWINGS

FIG. 1 shows a prospective view of the invention, a cup comprising a magnetic means to control loose check mechanisms for reciprocating devices including door closers.

FIG. 2 shows the magnetic invention positioned for quick adaptation onto a door closer device.

FIG. 3 shows a superior loose check mechanism for usage with the magnetic invention and closer of FIG. 2.

FIG. 4 shows the check vertically mounted onto the closer not affected by the magnetic invention, here in the basic tab set option in both disengaged and engaged positions.

FIG. 5 shows the check now horizontally mounted onto the closer with the magnetic invention, here in the immediate tab set option and available for engaging with light force as shown.

FIG. 6 shows an exposed top of view of the door closer of FIG. 5, adapted with the magnetic invention for controlling the loosely mounted superior check mechanism.

FIG. 7 shows a loose check mechanism having two compressive friction points, and with a stubbed non-variable trigger for usage with the magnetic invention and closer of FIG. 8.

FIG. 8 shows an exposed top view of a door closer adapted with the magnetic invention for controlling the non-variable two point check of FIG. 7.

FIG. 9 shows another loose check having two friction points and with an angular non-variable trigger, for usage with the magnetic invention and closer of FIG. 12.

FIG. 10 shows another loose non-variable check having two friction points comprising a circular aperture, also for usage with the magnetic invention and closer of FIG. 12.

FIG. 11 shows another loose non-variable check having four friction points also for usage with the magnetic invention and closer of FIG. 12.

FIG. 12 shows an exposed top of view of a door closer adapted with the magnetic invention for similarly controlling the non-variable checks of FIGS. 9-11.

FIGS. 13A-13D shows a variety of inventive magnetic cups and fastener means all for quick adaptation onto most any basic door closer device.

FIG. 14 shows another magnetic invention comprising a temporary magnetic wheel for utilizing the progressive tab set option.

FIG. 15 shows a door closer mounted with the magnetic invention of FIG. 14, the loose check held idle in the immediate tab set option, and the progressive magnet also in the idle position.

FIG. 16 shows the progressive magnet of FIG. 15 now engaging the loose check mechanism for utilizing the progressive tab set option.

FIG. 17 shows a reciprocating device and a loose check with the magnetic invention capable of basic, immediate, and progressive tab set options, and a low-voltage operator for converting a normal door closer into an inexpensive door opener.

FIG. 18 shows a door in the closed position with the device of FIG. 17, functioning only as a normal door closer without any additional power.

FIG. 19A shows a remote signal to the device preparing to engage the progressive tab set option, useful to assist with opening the door of FIG. 18.

FIG. 19B shows the progressive tab set option now engaged, permitting the device to assist with opening and holding the door of FIG. 20.

FIG. 20 shows the door while still in the closed position with the engaged device of FIG. 19B.

FIG. 21 shows the device returning to a normal engaged position and assisting to open the door of FIG. 22.

FIG. 22 shows the opened door operated by the returning device of FIG. 21.

FIG. 23 shows a reference list.

### BEST MODES FOR CARRYING OUT THE INVENTION

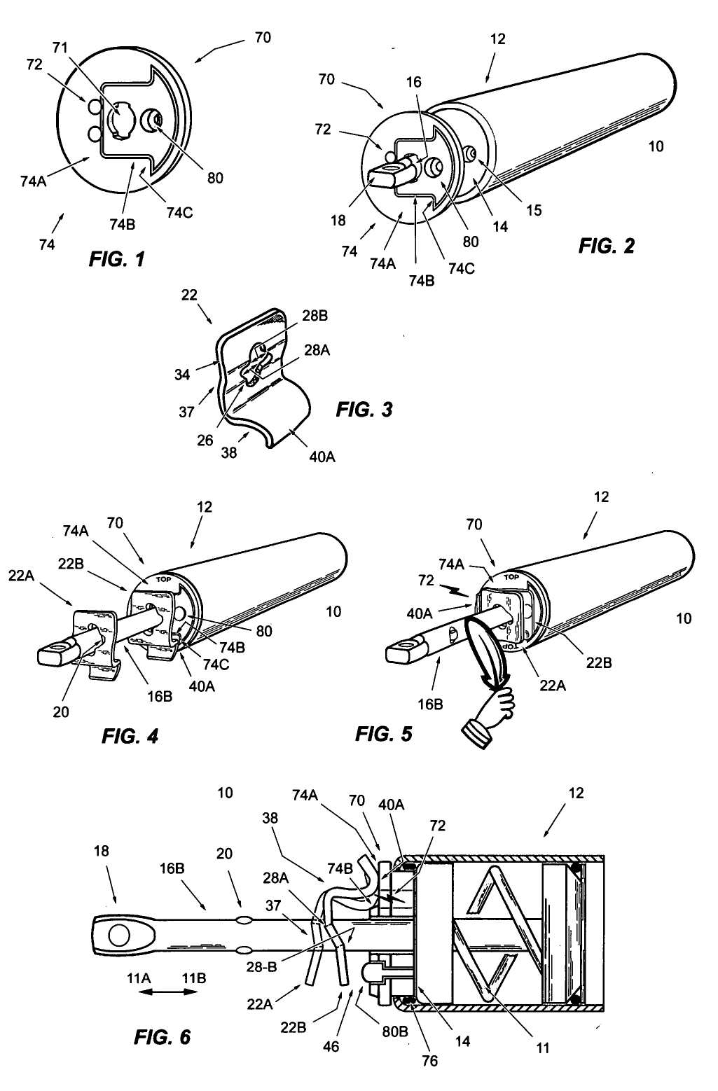

FIGS. 1-6 are taught together showing the invention, a magnetic means 72 to control loose checks 22 for reciprocating devices 10. The magnet 72 may be housed within a plastic cup 70, perhaps containing twin primary magnets 72. Projected surfaces 74 include a land 74A permitting the check 22 smooth rotations onto the trigger area 40, including the variable convex surface 40A. A lock 74B is mostly for securing the trigger 38 while in the disengaged check 22A. A check stop 74C is for positioning the engaged check 22B vertically when using the basic tab set. An option port 80 is provided for various reasons described below.

The best magnet 72 seems to be Neodymium Iron Boron (NdFeB). According to the industry they are the most powerful “rare earth” magnets known to mankind, which are capable of providing 4-5 times more power than ceramic magnets. They are also very hard which creates a durable plane for the convex surface 40A. The only thing that can weaken NdFeB magnets are temperatures of over 250° F. Therefore, it is suggested that the magnet 72 be applied into the cup 70 afterwards as temperatures of molten plastic can reach over 450° F.

It is important that the reader understand that the exclusive invention herein consist of the primary magnet 72 and the projected surfaces 74, wherein the cup 70 merely provides expediency for the invention.

FIG. 2 shows a retrofit installation procedure for the cup 70 through the aperture 71, onto the rod 16 for the closer device 10. It is strongly suggested that the magnetic invention 72 be fitted to the end cap 14 at manufacturing for the device 10. Note that when retrofitting the cup 70 onto a closer 10, the user must position the cup 70 to clear the rod hub 18 and lugs 20 which are common on many basic devices 10. An option port 80 is offered perhaps for a rivet fastener 80A to communicate with an end cap port 15. The cup 70 and magnet 72 may be used for left or right doors (not shown) by simple orientation.

FIG. 3 shows a superior loose check 22 housing an aperture 26 which opposes friction points 28 defined as the fulcrum 28A and the counter 28B. The aperture 26 is created within a structure 34 comprising offset planes 37, all components attached to a trigger 38 utilizing an arched, ovoid, or convex surface 40A. The unique shape of the trigger 38 does not allow pinched fingers for the user. Other variable trigger areas (40) including an installed pad or clip (40B), and an adjustable screw (40C) are defined in U.S. Pat. No. 6,032,331.

FIG. 4 shows the check 22 of FIG. 3 now mounted vertically onto the device 10 for basic tab set, as it is typically moved by the user from disengaged 22A to engage 22B. While in this basic tab set option, the magnet 72 (hidden) has absolutely no affect on the check 22. However, the projected surfaces 74 including the land 74A, the lock 74B, and the stop 74C help maintain the trigger 38 and convex 40A to the cup 70.

FIG. 5 shows the check 22 supported horizontally by the magnet 72 (hidden), now positioned for immediate tab set. The loose check tab 22 is drawn sideways to freely travel on the extended rod 16B as the door (not shown) opens and closes. To engage 22B, the user need only touch the check 22A with no more force than the touch of a feather held within the hand. To disengage 22A, the door needs to be bumped slightly outward and the magnet 72 (hidden) will draw the trigger 40A to release the rod 16B. Note that the user can apply slight inward force to the door for securing the engaged tab 22B more firmly onto the rod 16B. This will help prevent the door from accidental closure due to an unintentional bump. Certainly the user can choose the basic tab set option such as for moving furniture, by simply again rotating the disengaged check 22A to vertical as in FIG. 4.

FIG. 6 shows the unique ease of operation, installation, and lack of moving parts for the magnetic invention 72 contained within cup 70. The opt port 80 may also comprise a button 80B to possibly cancel the check 22A by closing the functional gap 46, as when the user forcefully attempts to close a door while its held by the engaged check 22B. Perhaps these inventions may permit the magnet 72 certain movement by the biasing means 11. This could eliminate the cup 70 entirely, or at least require a smaller diameter to better inset within the body 12. No specific fasteners 76 are defined to attach the cup 70 and magnet 72 onto the device 10. However, suggested are a ring 76 to grip the cup 70 comprising rubber, plastic, or actually molded into the end cap 14 if too made of durable plastic.

Note that the points 28A and 28B comprised within the structure 34 have offsetting planes 37, which allow the check 22 to substantially rotate on the extended rod 16B. This rotation is limited only by the lock 74B contacting the trigger area 40, in this illustration having a convex trigger 40A. Thus, when not in use the points 28 act as bearings or guides permitting the unusually smooth motion for the check 22 from engaged 22B to disengaged 22A and back to engaged 22B. Also note that the points 28A and 28B oppose at a distance that is less than the diameter of the rod 16B. Thus, the check 22 is greatly balanced and laterally stable on the surface of the rod 16B.

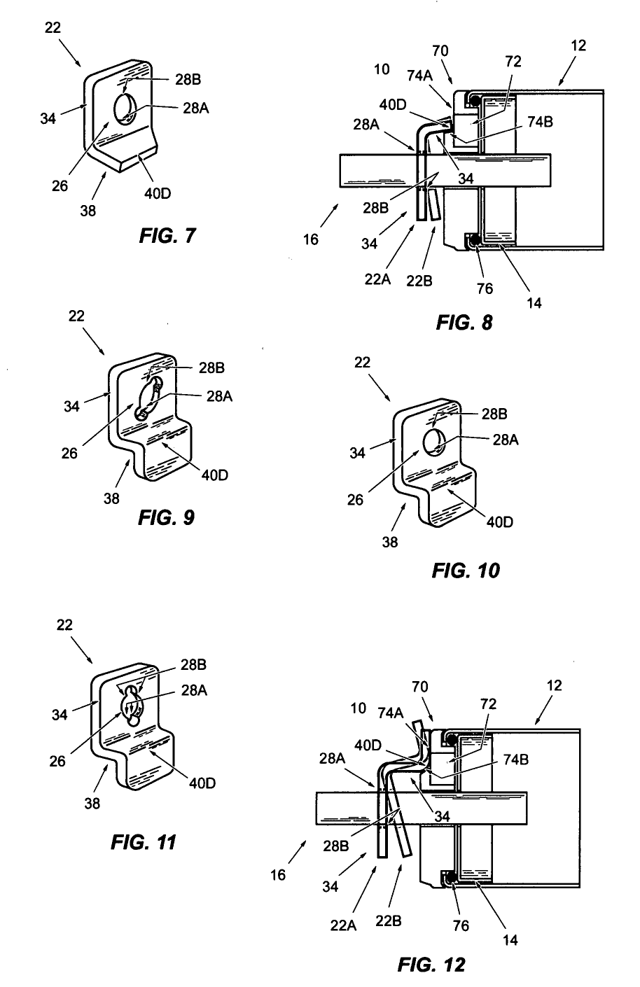

However, as shown in FIGS. 7-12 the checks 22 comprise an aperture 26 within a flattened structure 34 and a non-variable trigger area 40D. Note that the projection of the trigger 38 could be stubbed or angled to entirely omit any convex surface 40A. Such a trigger or lack thereof is independent of the variable trigger as defined in U.S. Pat. No. 6,032,331. A non-variable trigger 40D remains constant along the flattened plane of the trigger 38. Also note the acutely reduced functional gap 46.

FIGS. 7-8 are taught together showing a loose check 22 with an aperture 26 having only two points 28A and 28B, and, a stubbed trigger 38 all applicable to the magnetic invention 72. The leading edge of the trigger 38 creates a sufficient non-variable trigger area 40D for controlling the check 22 by the magnet 72. By simply modifying the projected surfaces 74 mostly to include the land 74A and the lock 74B, the disengaged check 22A is centralized so that the points 28A and 28B within the flattened structure 34 do not contact the rod 16 until the user touches towards engage check 22B. Again, to disengage 22A the door (not shown) needs to be bumped slightly outward and the magnet 72 will draw the trigger 38 and non-variable area 40D to release the rod 16.

FIGS. 9-12 are taught together showing several loose check varieties including two point 28A and 28B checks 22 as in FIGS. 9-10, and a four point 28A and 28B check 22 as in FIG. 11. All the checks 22 comprise triggers 38 also including non-variable trigger areas 40D. Note that with these suggested checks 22, the cup 70 might omit the lock 74B as the land 74A could create sufficient control to the flattened trigger 38 and non-variable trigger area 40D. Again, because of the flattened structure 34, the disengaged check 22A is centralized so that the points 28A and 28B do not contact the rod 16 until engaged 22B.

In the inventor's opinion there seems to be no leverage advantage to an aperture 26 having points 28A and 28B by a flattened structure 34, and a non-variable trigger area 40D. Wherein, as with FIG. 6 the offset structure 34 and the substantial variable trigger area 40A permits the engaged check 22B to exert a greater leverage by the points 28 onto the rod 16, and maintain a greater functional gap 46.

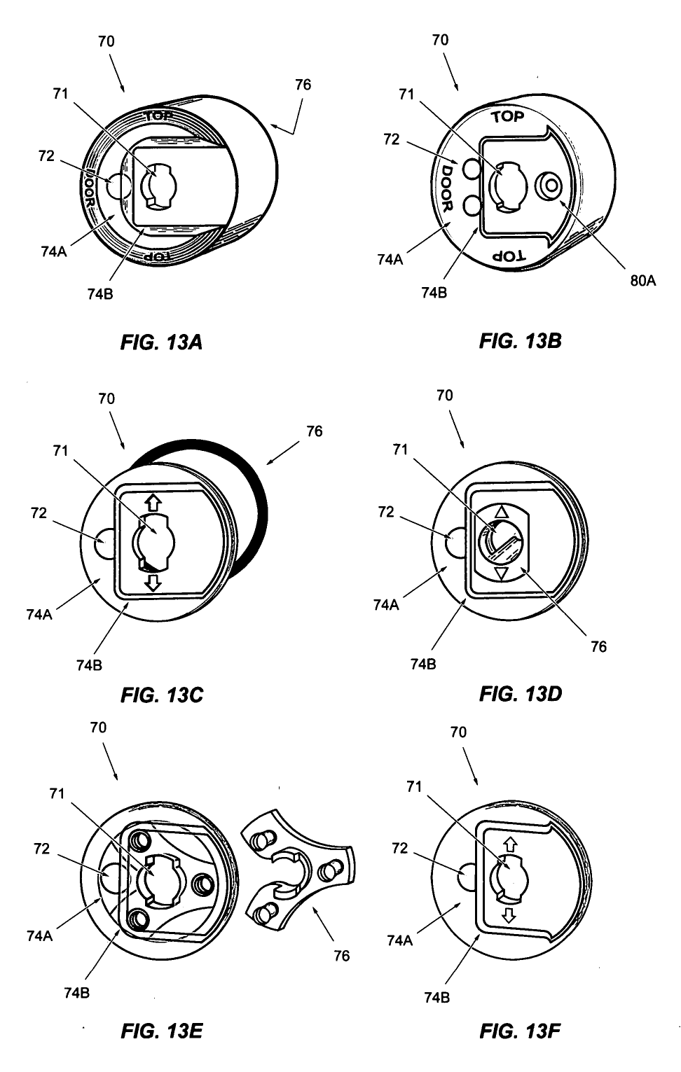

FIGS. 13A-13F shows a variety of inventive magnetic cups 70 and fastener means 76, all for quick adaptation onto most any basic door closer device 10 (not shown). Note the common independent elements for the cups 70 consist of a magnet 72 and projected surfaces 74 including a land 74A and a lock 74B.

FIG. 13A shows a cup 70 having no fastener instead relying on a compression fit onto a closer. Note the inward projected surfaces 74 especially the land 74A. FIG. 13B shows a cup 70 having dual magnets 72 and a rivet fastener 80A corresponding with the option port 80. FIG. 13C shows a cup 70 having a ring fastener 76 similar to FIG. 6. FIG. 13D shows a cup 70 having a center bushing fastener 76 to secure into a modified end cap 14. FIG. 13E shows a cup 70 having a winged fastener 76 installed similar to FIG. 13C. FIG. 13F shows a factory installed cup 70 perhaps molded onto the end cap 14 for a closer 10.

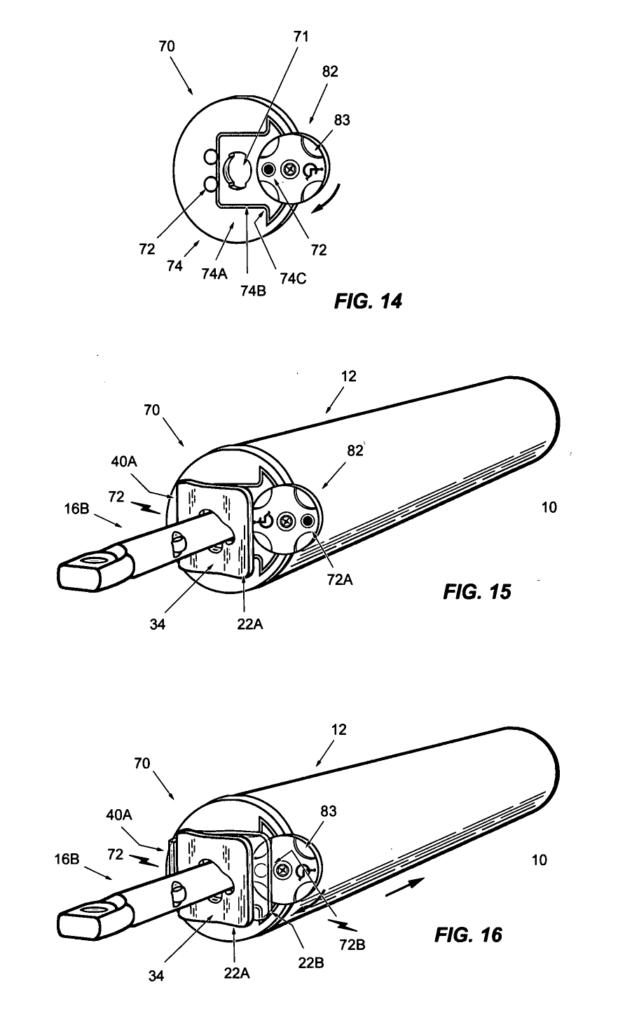

FIGS. 14-16 are taught together showing another magnetic invention 72 provided within a wheel 82, for progressively holding the engaged check tab 22B that every outward position. This feature could be practical for users of mobility devices. FIG. 15 shows the disengaged tab 22A held horizontally by the primary magnets 72, positioned for the immediate tab set similar to FIG. 5. FIG. 16 shows preparation for progressive tab by rotating the wheel 82 now 180° using a finger to the notches 83, which magnetically 72B draws the structure 34 to engage the tab 22B. As a closed door (not shown) is pushed outward toward opened, the combined magnets 72 progressively hold the check 22 at every outward position to accommodate the user even if the mobility device strikes the door.

Once outside, the user can cancel the check tab 22A by again rotating the wheel 82 to idle 72A, then bumping the door 62 for closure. However, if the device 10 provides a damper 50 (not shown) as in U.S. Pat. No. 6,640,387, the door can be closed while the extended rod 16B is held by the tab 22. This will assist to open the door 62 upon return trip, wherein the user can then rotate the wheel 82 and bump the door 62 for closure once inside. By hiding magnets (not shown) behind the wheel 82 at each 180° interval, a “click” stop is created for locking the wheel in the off 72A and on 72B positions.

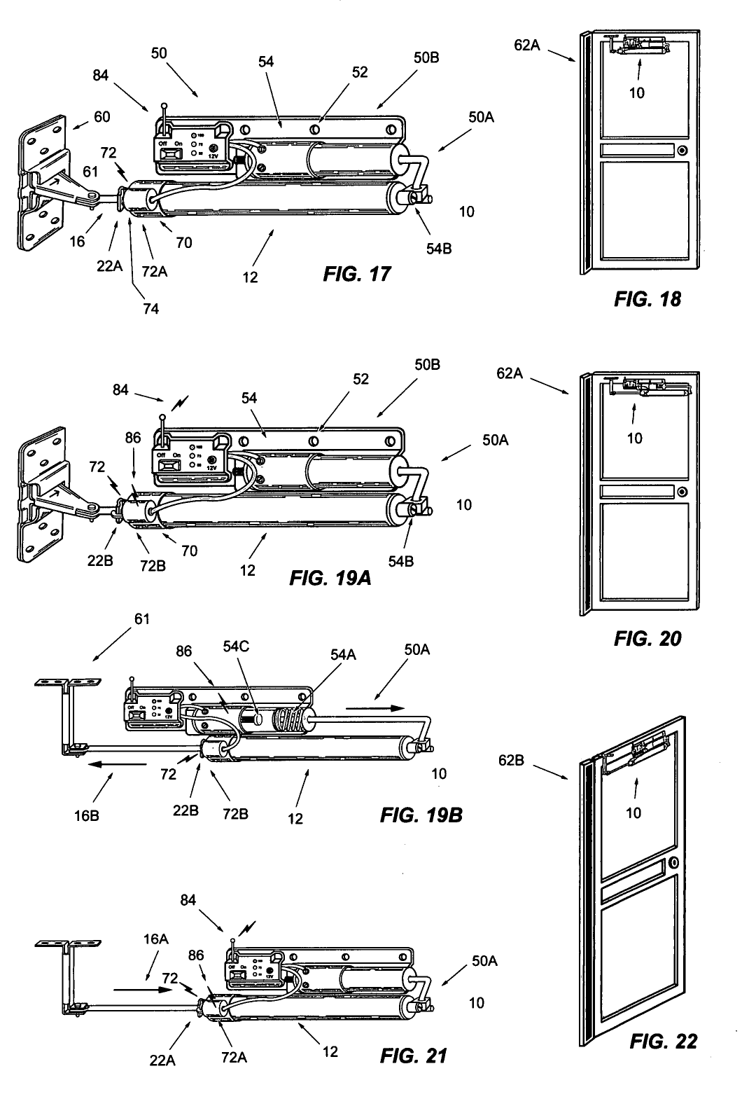

FIGS. 17-22 are taught together showing a closer device 10 with the magnet 72 comprised within the cup 70. A damper 50 as defined in U.S. Pat. No. 6,640,387, provides a hinge bracket 50A to the device 10, and a fixated bracket 50B to the door 62A. The damper 50 permits the device 10 to normally act as a closer only, until remotely activated 84 to engage a lineal actuator 54. Note the magnet 72 maintains the loose disengaged check 22A horizontally, however at any time permits the user to opt for basic tab as with FIG. 4. FIG. 18 shows a closed door 62A and device 10 of FIG. 17 under normal operation with no additional power to the device 10.

FIG. 19A shows the remote activator 84 setting in motion a power supply 86 for a solenoid or small motor, to engage the check 22B with a magnetic means 72B. This prepares the device 10 and the engaged check 22B for progressive tab set similar to FIG. 16. The power supply 86 might comprise a rechargeable 12-24V DC battery, which may be capable of operating for months between charges. Note that several doorjamb brackets 61 are shown.

FIG. 19B shows the remote activator 84 setting in motion the power supply 86 to the lineal actuator 54, to advance the drive 54C and extend the damper spring 54A and bracket 50A. Note that the drive 54C only requires approx. 6 inches of extension to fully open an average door 62B, and is shown after advancing the spring 54A and bracket 50A. The operator 54 does not require power to open and hold the door 62B, as the extended rod 16B, and the extended bracket 50A, and the energy of the damper spring 54A are all held only by the engaged check 22B. FIG. 20 shows that the low-voltage operator 54 of FIG. 19B can energize for activation while remaining in the closed door position 62A.

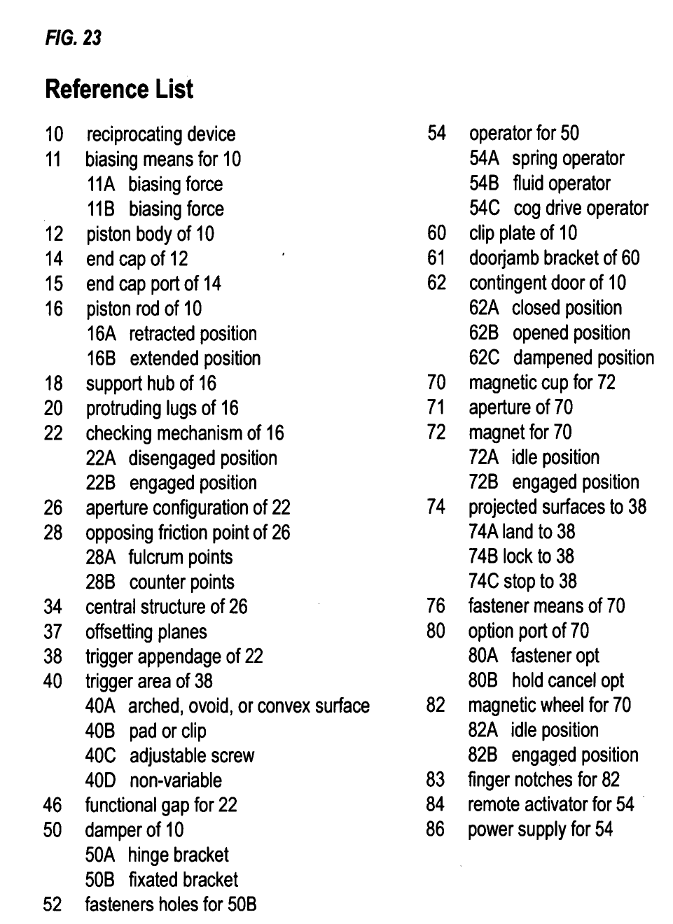

FIGS. 21-22 shows that the bracket 50A has caused the opened door 62B by the engaged check 22B. After a timed interval, the remote activator 84 can again set in motion the power supply 86 to the solenoid, which disengages the check tab 22A to retract the rod 16A and cause the closed door 62A. FIG. 22 clearly shows that the combined inventions have caused the opened door 62B, and, note that the device 10 appears to be under normal operation as though not equipped with any additional components. Please note that if the remote 84 is inadvertently activated while in the opened door 62B, the advancing bracket 50A will only cause the door again towards the closed 62A which can overcome possible damage to the device 10.

FIG. 23 shows a reference list.

### INDUSTRIAL APPLICABILITY

The present invention comprises the use of magnetism adapted for triggering loose check mechanisms to engage and release from biasing rods, including those of door closers. No other closer has ever offered both basic and immediate tab set options derived from a loose check. It is also important that the reader understand that only these inventions create this first known feather touch check for door closers, while also eliminating complex fixed check mechanisms. Furthermore, by modifying a cup to the inventive magnet including the land and the lock, the invention can be added onto non-variable check mechanisms as the industry continues to favor.

By adding a simple magnetic wheel, a single closer is also now capable of providing basic, immediate, and progressive tab set. The combined inventions also create the first door operator comprising an inexpensive low-voltage rechargeable battery, perhaps for residential industries. Such a device would act as a reliable closer only, until remotely energize with timed intervals to assist by opening & closing the door. Other industrial applications include automotive lift supports where such devices currently rely on internal power to hold opened. By including a check mechanism and magnet might someday create a preferred device for hoods, hatches, and trunks lids.

The particular embodiments of the present invention which have been illustrated and discussed herein are for demonstrative purposes only, and are not considered limited upon the scope of the appended claims. In these claims set forth it is my intent to all the inventions discovered, except as I am limited by the prior art. From this disclosure, various changes or improvements may occur wherein any applicable claims are intended to be included therein.

I claim:

1. A cup (70) for causing a loose compressive friction check mechanism (22) to disengage (22A) and engage (22B), said check (22) utilized to hold then return the linear biasing forces (11A) and (11B) of a reciprocating device (10) and any object (62) attached thereto, including a door closer device (10) comprising at least one rod (16) which linearly reciprocates from within a body (12) containing a biasing means (11); said rod (16) loosely mounted with said check (22) through an aperture (26) housed within a structure (34) comprising opposed friction points (28A) and (28B) to compressively hold the extended rod (16B); said check (22) further providing a trigger means (38) disposing a trigger area (40) to lever said check (22), said cup (70) consisting
a magnetic means (72) adapted between said loose check (22) and said device (10);
projected surfaces (74) consisting of a land (74A) for permitting smooth rotations for said trigger area (40), and a lock (74B) for securing said trigger means (38) in a disengaged (22A) position;
whereby said magnet (72) willingly drafts said loose check (22) onto said extended rod (16B) to engage (22B) and disengage (22A), by control of said trigger means (38) disposing said trigger area (40) contiguous with said projected surfaces (74), for holding then returning said object (62).

2. The cup (70) for causing the loose compressive friction check mechanism (22) to engage (22B) and disengage (22A) of claim 1, further consisting
said cup (70) to include a fastener means (76) fixable onto said closer (10);
whereby said magnet (72) willingly drafts said loose check (22) onto said extended rod (16B) to engage (22B) and disengage (22A), by control of said trigger means (38) disposing said trigger area (40) contiguous with said projected surfaces (74), for holding then returning said object (62).

3. The cup (70) for causing the loose compressive friction check mechanism (22) to engage (22B) and disengage (22A) of claim 1, further consisting
said magnet (72) is composed of Neodymium Iron Boron (NdFeB);
whereby said magnet (72) willingly drafts said loose check (22) onto said extended rod (16B) to engage (22B) and disengage (22A), by control of said trigger means (38) disposing said trigger area (40) contiguous with said projected surfaces (74), for holding then returning said object (62).

4. A method for causing a loose compressive friction check mechanism (22) to disengage (22A) and engage (22B), and said check (10) utilized to hold then return the linear biasing forces (11A) and (11B) of a reciprocating device (10) and any object (62) attached thereto, including a door closer device (10) comprising at least one rod (16) which linearly reciprocates from within a body (12) containing a biasing means (11); said rod (16) loosely mounted with said check (22) through an aperture (26) housed within a structure (34) comprising opposed friction points (28A) and (28B) to compressively hold the extended rod (16B), said check (22) further providing a trigger means (38) disposing a trigger area (40) to lever said check (22), said method:
adapting a magnetic means (72) between said loose check (22) and said device (10);
projecting surfaces (74) to consist of a land (74A) for permitting smooth rotations for said trigger area (40), and, a lock (74B) for securing said trigger means (38) in a disengaged (22A) position;
whereby said magnet (72) willingly drafts said loose check (22) onto said extended rod (16B) to engage (22B) and disengage (22A), by control of said trigger means (38) disposing said trigger area (40) contiguous with said projected surfaces (74), for holding then returning said object (62).

5. The method for causing the loose compressive friction check mechanism (22) to engage (22B) and disengage (22A) of claim 4, further
fastening (76) said cup (70) onto said closer (10);
whereby said magnet (72) willingly drafts said loose check (22) onto said extended rod (16B) to engage (22B) and disengage (22A), by control of said trigger means (38) disposing said trigger area (40) contiguous with said projected surfaces (74), for holding then returning said object (62).

6. The method for causing the loose compressive friction check mechanism (22) to engage (22B) and disengage (22A) of claim 4, further
composing said magnet (72) of Neodymium Iron Boron (NdFeB);
whereby said magnet (72) willingly drafts said loose check (22) onto said extended rod (16B) to engage (22B) and disengage (22A), by control of said trigger means (38) disposing said trigger area (40) contiguous with said projected surfaces (74), for holding then returning said object (62).

7. A cup (72) for causing a loose compressive friction check mechanism (22) to disengage (22A) and engage (22B) the tensile strength of a rod (16), said check (22) provided to maintain certain biasing forces (11A) and (11B) for supporting and releasing any object (62) attached by said rod (16); said check (22) loosely mounted onto said rod (16) through an aperture (26) housed within a structure (34) comprising opposed friction points (28A) and (28B) adapted to said rod (16); said check (22) further providing a trigger means (38) disposing a trigger area (40) to lever said check (22), consisting
a magnetic means (72) adapted to said loose check (22);
projected surfaces (74) contiguous with said trigger means (38);
whereby said magnet (72) positions said loose check (22) to compressively engage (22A) and disengage (22B) said rod (16), by control of said trigger means (38) disposing said trigger area (40) contiguous with said projected surfaces (74), for withstanding said forces (11A) and (11B) by utilizing said tinsel strength of said rod (16) for supporting and releasing said object (62).

8. The cup (70) for causing the loose compressive friction check mechanism (22) to engage (22B) and disengage (22A) of claim 7, further comprising
said projected surfaces (74) consisting of a land (74A) for permitting smooth rotations for said trigger area (40), and a lock (74B) for securing said trigger means (38) in a disengaged (22A) position;
whereby said magnet (72) positions said loose check (22) to compressively engage (22A) and disengage (22B) said rod (16), by control of said trigger means (38) disposing said trigger area (40) contiguous with said projected surfaces (74), for withstanding said forces (11A) and (11B) by utilizing said tinsel strength of said rod (16) for supporting and releasing said object (62).

9. The cup (70) for causing the loose compressive friction check mechanism (22) to engage (22B) and disengage (22A) of claim 7, further comprising
said cup (70) to include a fastener means (76) fixable onto said closer (10);
whereby said magnet (72) positions said loose check (22) to compressively engage (22A) and disengage (22B) said rod (16), by control of said trigger means (38) disposing said trigger area (40) contiguous with said projected surfaces (74), for withstanding said forces (11A) and (11B) by utilizing said tinsel strength of said rod (16) for supporting and releasing said object (62).

10. The cup (70) for causing the loose compressive friction check mechanism (22) to engage (22B) and disengage (22A) of claim 7, further comprising
said magnet (72) is composed of Neodymium Iron Boron (NdFeB);
whereby said magnet (72) positions said loose check (22) to compressively engage (22A) and disengage (22B) said rod (16), by control of said trigger means (38) disposing said trigger area (40) contiguous with said projected surfaces (74), for withstanding said forces (11A) and (11B) by utilizing said tinsel strength of said rod (16) for supporting and releasing said object (62).
